(19) United States
(12) Patent Application Publication
(10) Pub. No.: US 2003/0121038 A1
(43) Pub. Date: Jun. 26, 2003

(54) Caching system and method supporting improved trick mode performance in video decoding systems

(76) Inventors: Gaurav Aggarwal, Bangalore (IN); Arun Gopalakrishna Rao, Bangalore (IN); Marcus Kellerman, Aliso Viejo, CA (US); David Erickson, Estival, SC (US); Jason Demas, Irvine, CA (US); Sandeep Bhatia, Bangalore (IN); Girish Huhmani, Bangalore (IN)

Correspondence Address: MCANDREWS HELD & MALLOY, LTD, 500 WEST MADISON STREET, SUITE 3400, CHICAGO, IL, 60661

(21) Appl. No.: 10/317,454

(22) Filed: Dec. 11, 2002

Related U.S. Application Data
(63) Continuation-in-part of application No. 09/951,693, filed on Sep. 12, 2001.
(60) Provisional application No. 60/426,850, filed on Nov. 15, 2002.

(51) Int. Cl. H04N 5/445

(52) U.S. Cl. 725/37; 725/40

(57) ABSTRACT

A caching system and method supporting improved trick mode performance in video decoding systems are presented herein. During a rewind operation, various pictures of an EP-EP segment that are decoded to display the last picture in the EP-EP segment are cached. The pictures are cached to avoid repetitive decoding.

### RELATED APPLICATIONS

This application is a continuation-in-part of U.S. app. Ser. No. 09/951,693, filed Sep. 11, 2001 and entitled “COMMAND PACKETS FOR PERSONAL VIDEO RECORDER” by Demas et. al., which is incorporated by reference herein.

This application also claims priority from Provisional Application, Serial No. 60/426,850, filed Nov. 15, 2002, by Kellerman, et. al., which is incorporated by reference herein.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates to video recorder and playback systems, and more particularly to controlling the presentation of content.

A special class of MPEG-2 streams, known as Headend In The Sky (HITS) streams, does not include I-pictures, in order to increase the video compression and reduce the bandwidth required to transmit a video stream. Instead, HITS streams use a progressive refresh mechanism to build reference pictures. The progressive refresh mechanism of HITS mandates that each P-picture have at least one intra-coded slice(s), where a slice is 16 horizontal lines of pictures. Furthermore, the last intra-coded slice(s) in a P-picture is just below the last intra-coded slice(s) of the previous P-picture. The top slice is intra-coded for a P-picture following a P-picture that has its last intra-coded slice at the bottom of the picture. The number of intra-coded slices in a P-picture is called the “refresh-rate” of the stream. The streams also ensure that the slices above the intra-coded slice(s) predict only from those slices of the previous P-picture that are above the current intra-coded slices. Thus, the slices are progressively refreshed from top to bottom. This scheme ensures that if a series of pictures is decoded starting from a P-picture whose first-slice is intra-coded, then a “clean” refreshed picture is built after all slices have been progressively refreshed. The picture whose first-slice is intra-coded is called an Entry Point (EP) picture. Typical values of slice refresh rates are 1 and 3 for a stream with a vertical sized of 480 pixels (30 slices, each of 16-lines). Thus, a clean picture may be built by decoding 30 P-pictures when the refresh rate is 1, and 10 P-pictures when the refresh rate is 3.

To perform a Rewind operation on a HITS stream, a video decoder first builds a clean reference using the progressive refresh mechanism, and then decodes the intervening pictures between the clean reference and the current picture in the rewind sequence.

Thus, an existing decoder has to decode multiple pictures for displaying a single picture. If a decoder is unable to decode multiple pictures in the given time limit for getting ready with a new picture for display, then the video quality suffers.

Further limitations and disadvantages of conventional and traditional systems will become apparent to one of skill in the art through comparison of such systems with the invention as set forth in the remainder of the present application with reference to the drawings.

### BRIEF SUMMARY OF THE INVENTION

A caching system and method supporting improved trick mode in performance in video decoding systems are presented herein. During rewind of a plurality of pictures, each of the intermediate pictures is decoded to display the last picture in the plurality of pictures. The decoded intermediate pictures are stored in a cache. During rewind, each picture is displayed directly from the cache, thereby avoiding repetitive decoding.

In one embodiment, the plurality of pictures comprises an EP-EP segment in a HITS stream, wherein each picture in the EP-EP segment is decoded in order to display the last picture of the EP-EP segment. Each picture that is decoded is stored in a cache. The picture stored in the cache can comprise a scaled down picture, thereby saving memory. During rewind, each picture is directly displayed from the cache. foregoing further reduces the amount of memory needed. During the rewind operation, the B-pictures in the EP-EP segment are decoded from the P-pictures stored in the cache. The P-pictures are displayed directly from the cache.

In another embodiment, the pictures of one EP-EP segment are decoded and stored while the pictures of another EP-EP segment are displayed. The foregoing improves the performance of the video decoder.

In another embodiment, the pictures of another EP-EP segment overwrite the pictures of the EP-EP segment that have been displayed. The foregoing reduces the amount of memory that is used to cache the pictures.

These and other advantages and novel features of the present invention, as well as illustrated embodiments thereof will be more fully understood from the following description and drawings.

### BRIEF DESCRIPTION OF SEVERAL VIEWS OF THE DRAWINGS

A better understanding of the invention can be obtained when the following detailed description of various exemplary embodiments is considered in conjunction with the following drawings.

FIG. 1 is a system diagram illustrating an embodiment of a personal video recorder system in accordance with certain aspects of the present invention;

FIG. 2 is a system diagram illustrating an embodiment of a recording process;

FIG. 3 is a system diagram illustrating an embodiment of a video playback process;

FIG. 4 is an exemplary HITS stream;

FIG. 5 is a block diagram of an exemplary video decoder in accordance with an embodiment of the present invention;

FIG. 6 is a flow diagram for caching HITS stream pictures;

FIG. 7 is a flow diagram for caching HITS stream P-pictures; and

FIG. 8 is a flow diagram for displaying a HITS stream while caching another HITS stream.

### DETAILED DESCRIPTION OF THE INVENTION

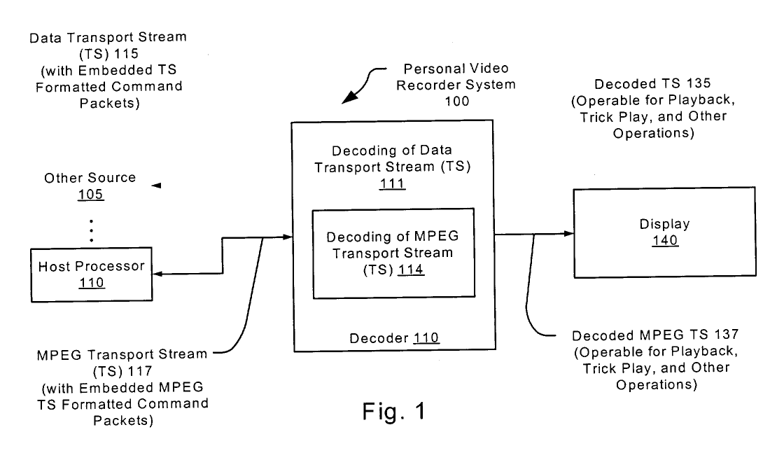

FIG. 1 is a system diagram illustrating an embodiment of a personal video recorder system 100 that is built in accordance with certain aspects of the present invention. The personal video recorder system 100 includes a decoder 120 that receives a data transport stream (TS) 115 from some source. The TS 115 may be received by the decoder 120 from a host processor 110, . . . , or any other source 105 without departing from the scope and spirit of the invention. The host processor 110 or the any other source 105 is the device that controls the playback (including trick play playback) of the data. The host processor 110 or the any other source 105 and the decoder 120 may be included within a single device or separate devices.

The decoder 120 is operable to perform decoding of the TS 115, as shown in a functional block 122 within the decoder 120. Similarly, the decoder 120 is operable to perform decoding of the MPEG TS 117, as shown in a functional block 124 within the decoder 120. The now decoded TS 135, is passed to an output device shown as a display 140. Again, other output devices may be employed to accommodate various data types, including audio data types. The use of a display 140 is used to show the exemplary situation of video data TSs. The display 140 is operable to perform playback of the now decoded TS 135. The decoded TS 135 may be of various data types, including audio and video data types.

The decoded TS 135 is now operable for playback, trick play, and other operations within the output device. In one particular situation, the decoded TS may be a decoded MPEG TS 137 that is operable for playback, trick play, and other operations.

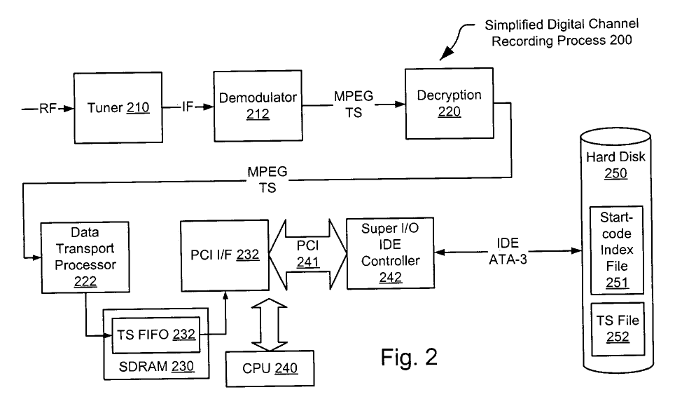

FIG. 2 is a system diagram illustrating an embodiment of a simplified digital channel recording process 200 that is performed in accordance with certain aspects of the present invention. The FIG. 2 shows one embodiment where digital channel recording may be performed, in a simplified manner when compared to previous systems, using certain aspects of the present invention. The recording process of a digital video stream is given in the FIG. 1. In this embodiment, a personal video recorder (PVR) digital-channel-recording process can be employed as set forth below.

The selected video service is contained in a transport stream (TS) that is received as shown in a radio frequency (RF) signal, which is received by a tuner 210. The tuner 210 is operable to down-convert the channel that contains the transport stream, from RF to intermediate frequency (IF). The Demodulation block, shown as a demodulator 215, demodulates the IF to base-band digital data and outputs the transport stream (shown as an MPEG TS) and sends the data to the decryption block 220.

The decryption block 220 decrypts the packets of the TS into clear data if the service is authorized. This output TS stream goes to the Data Transport Processor 225. The Data Transport Processor selects the requested service and then re-multiplexes it into a new TS and stores the new TS data in a TS FIFO buffer 232 in synchronous dynamic random access memory (SDRAM) 230.

This new TS is then transferred to a hard disk 250. The data within the TS FIFO buffer 232 is operable to be communicated to the hard disk 250. The CPU 240 controls the storing of the data from the TS FIFO 232 to the hard drive (hard disk 250). This is done using DMA engines which sends the data over the PCI bus 241 to the super I/O controller chip 245 containing the IDE interface to the hard drive (hard disk 250) itself. If desired, the IDE ATA-3 Advanced Technology Attachment Interface with Extensions—AT Attachment 3 Interface protocol is employed between the super I/O controller chip 245 and the hard disk 250. A Start Code Index Table (SCIT) 251 is also generated and stored in the hard disk 250 (see below for detailed description). A TS file 252 is then stored within the hard disk 252.

The embodiment of the present invention shown in the FIG. 2 shows how a TS may be generated and stored in a hard disk 250.

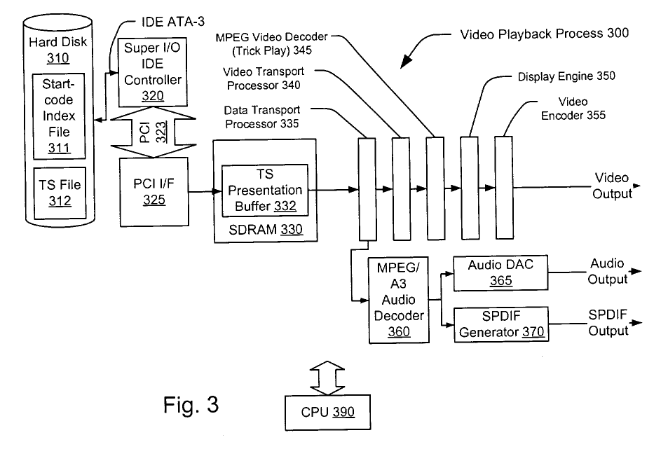

FIG. 3 is a system diagram illustrating an embodiment of a video playback process 300 that is performed in accordance with certain aspects of the present invention. The particular example of video data retrieval and playback is shown in the FIG. 3, but these aspects of the present invention are also extendible to retrieval and playback of other types of data, including audio data and other digital data types.

For a program recorded on the hard drive/hard disk 310, a personal video recorder, or other operable system, can play back that program using that which is described below in the system diagram of the FIG. 3. A processor, that may include a CPU 390, reads the TS data (shown as the TS file 312) from the hard drive/hard disk 310 based on the user selected playback mode. The correct TS data (from the TS file 312 within the hard drive/hard disk 310) is read into TS presentation buffer 332 within a SDRAM 330 using DMA engines.

Data may be read from the hard drive/hard disk 310 in a manner similar to the manner in which data is written into the hard drive/hard disk 310, a super I/O controller chip 320 may communicatively couple with the hard disk 310 and perform data transfer using the IDE ATA-3 protocol. The super I/O controller chip 320 then communicatively couples to the TS presentation buffer 332 within the SDRAM 330 via a PCI bus 323 and a PCI I/F 325. The data is output from the TS presentation buffer 332 and is then passed to a data transport processor 335. The data transport processor then de-multiplexes the TS into its PES constituents and passes the audio TS to an audio decoder 360 and the video TS to a video transport processor 340 and then to a MPEG video decoder 345 that is operable to decode and extract embedded, TS formatted command packets, which may include instructions to perform trick play functionality. The audio data is then sent to the output blocks, and the video is sent to a display engine 350. The display engine 350 is responsible for and operable to perform scaling the video picture, rendering the graphics, and constructing the complete display among other functions. Once the display is ready to be presented, it is passed to a video encoder 355 where it is converted to analog video using an internal digital to analog converter (DAC). The digital audio is converted to analog in the audio digital to analog converter (DAC) 365 while a Sony Philips Digital Inter-Face (SPDIF) output stream is also generated and transmitted.

The video TS comprises pictures that are compressed representations of individual images forming a video. The video decoder 345 decompresses the pictures, thereby recovering the individual images forming the video. Compression is achieved by taking advantage of both spatial and temporal redundancy in the image forming the video. Compression using temporal redundancy takes advantage of redundancies between video images recorded in substantially the same time period. Redundant features among the images are recorded in one picture referenced by other pictures. As a result, some pictures are data dependent on other pictures.

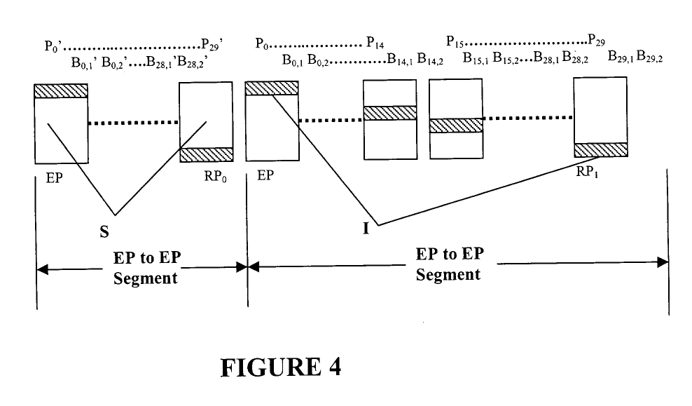

Referring now to FIG. 4, there is illustrated a block diagram describing an exemplary HITS stream. A HITS stream is a special class of MPEG-2 streams that includes P-pictures, P, and B-pictures, B, but do not include I-pictures. There are usually a uniform number of B-pictures, for example B₀₁ and B₀₂, between each of the P-pictures. HITS streams do not include I-pictures because I-pictures require the most memory and bandwidth. Instead, HITS streams use a progressive refresh mechanism to build reference pictures. In the progressive refresh mechanism, each P-picture, P, has at least one intra-coded slice(s), I, where a slice comprises 16 horizontal lines of pixels. Furthermore, the intra-coded slice(s) in a P-picture, e.g., P₁₅, are just below the intra-coded slice(s) of the previous P-picture, e.g., P₁₄. The top slice, I, is intracoded for a P-picture, P_{0,} following a P-picture, P, with an intracoded slice, I, at the bottom of the picture, RP₁. Additionally, the streams also ensure that the slices above the intra-coded slices, S, predict only from those slices of the previous P-picture that are above the current intracoded slice(s), I. The foregoing ensures that if a series of pictures is decoded starting from a P-picture whose first-slice is intra-coded, then a “clean” refreshed picture will be built after all slices have been progressively refreshed. The P-picture whose first-slice is intra-coded is called an Entry Point (EP) picture, EP. The P-picture immediately before the EP picture, EP, i.e., the P-picture with the I-slice(s), I, at the bottom of the picture, RP, will be referred to as a clean reference picture when it was decoded starting from an EP picture and all the intervening pictures were duly decoded.

The rewind operation on a HITS stream, starting from arbitrarily chosen picture, B_{29,2,} can be achieved by building the clean reference picture, RP₁, immediately preceding the arbitrarily chosen picture B_{29,2}, and decoding each intervening P-picture in the forward decode order before the chosen picture, B_{29,2}. Building the clean reference picture RP, involves decoding each P-picture in the EP to EP segment comprising RP₀, e.g., P₀′ . . . P₂₈′. While decoding the intervening P-pictures, the last two P-pictures are stored in memory. Upon decoding the last two P-pictures, P₂₈, P₂₉ before the chosen picture, B_{28,2}, the decoder can then decode the chosen picture. The foregoing is repeated for each picture in the rewind sequence. The decoded pictures for various pictures in the rewind sequence for the HITS stream illustrated in FIG. 20 are shown in the table below.

| Picture | |
|---|---|
| Displayed | Pictures Decoded |
| B_{29,2} | P₀′ . . . P₂₉′, P₀ . . . P₂₉ |
| B_{29,1} | P₀′ . . . P₂₉′, P₀ . . . P₂₉ |
| P₂₉ | P₀′ . . . P₂₉′, P₀ . . . P₂₈ |
| B_{28,2} | P₀′ . . . P₂₉′, P₀ . . . P₂₈ |
| B_{28,1} | P₀′ . . . P₂₉′, P₀ . . . P₂₈ |
| P₂₈ | P₀′ . . . P₂₉′, P₀ . . . P₂₇ |
| B_{27,2} | P₀′ . . . P₂₉′, P₀ . . . P₂₇ |
| B_{27,1} | P₀′ . . . P₂₉′, P₀ . . . P₂₇ |
| . | |
| . | |
| . | |
| B₀₂ | P₀′ . . . P₂₉′, P₀ |
| B₀₁ | P₀′ . . . P₂₉′, P₀ |
| P₀ | P₀′ . . . P₂₉′ |

During rewind of a HITS stream, the last picture of an EP-EP segment is displayed first. All the intervening pictures, P₀ . . . P₂₈ between the clean reference picture, RP₀ and the picture for display, e.g., B_{28,2}, are still decoded even though they are not used for display. This is because the intervening pictures, P₀. . . P₂₈, are used for predicting the subsequence pictures and once the prediction is over, the intervening pictures are discarded. These pictures are repeatedly decoded for displaying pictures in the reverse order. For example, intervening picture P₀ is decoded for displaying each of the pictures P₁ . . . B_{28,2}.

As can be seen, decoding pictures in the rewind sequence requires decoding large numbers of pictures. For example, for a HITS stream with a refresh rate of 1, there would be 30 P-pictures between the EP's. For pictures at the end of an EP to EP segment, an additional 30 P-pictures would have to be decoded. Therefore, the number of pictures that would have to be decoded is:

$$( Y + 1 ) {\sum }_{x = 0}^{29} ( 30 + ( x + 1 ) )$$

where Y=# of B-pictures between P-pictures

From the above formula, 1365 pictures are decoded to display 30 pictures in reverse order, or an average of 45.5 decoded pictures/displayed picture.

In accordance with the present invention, the intermediate pictures, P₀ . . . P₂₈ are cached while decoding to get to display the last picture of the EP-EP segment, e.g., B_{28,2}. By caching the intermediate pictures P₀ . . . P₂₈, the intermediate pictures need to be decoded only once. After decoding the intermediate pictures the first time, all the pictures in the EP to EP segment are already in memory, and there is no need to decode the pictures again.

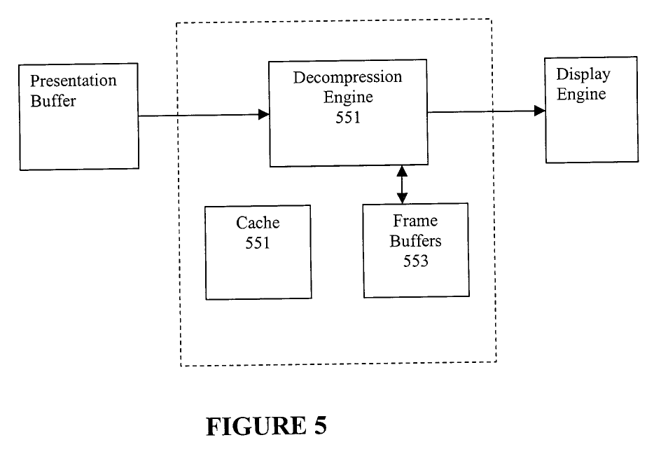

Referring now to FIG. 5, there is illustrated a block diagram of an exemplary video decoder 345 in accordance with an embodiment of the invention. The video decoder receives pictures form a presentation buffer and decodes the pictures for display. The decoded pictures for displaying are provided to the display engine. The video decoder 345 includes a decompression engine 551, a cache memory 552, and frame buffers 553. The decompression engine 551 performs the requisite decompression of received pictures, transforming the pictures into frames for display. As noted above, the pictures are data dependent from other pictures. Accordingly, the decompression engine 551 stores past and future prediction pictures in the frame buffers 553. Additionally, the decompression engine 551 can store reference pictures in the frame buffers as well. While decoding pictures for display that are data dependent on the pictures stored in the frame buffers, the decompression engine 551 uses the pictures stored therein to decode and provide the picture for display to the display engine 350. Additionally, the video decoder also includes a cache 552 for storing pictures therein, to facilitate decoding pictures for display.

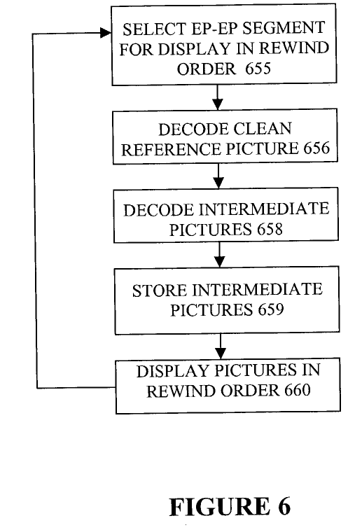

Referring now to FIG. 6, there is illustrated a flow diagram for storing the intermediate pictures during rewind of a HITS stream. At 655, the EP-EP segment for display in rewind order is selected. At 656, the clean reference picture RP0 is decoded and stored in a reference picture frame buffer 653. Each intermediate picture P₀ . . . B_{28,1} between the clean reference picture RP₀ and the last picture in the EP-EP segment, B_{28,2} is decoded 658 and stored 659 in the cache memory 652. In one embodiment, the pictures can be stored as scaled down pictures. For example, the decompression engine can use ½ scaling for the both the vertical and horizontal dimension, thereby requiring ¼ the amount memory. Once each of the pictures are decoded and stored in the cache memory 652, each picture is displayed in the rewind order 660 until each picture of the EP-EP segment is displayed. When each picture of the EP-EP segment has been displayed, 655-660 are repeated for the next EP-EP segment in the rewind order.

Alternatively, the P-pictures P₀ . . . P₂₈ are stored in the cache 652. While displaying the pictures in the reverse order, the P-pictures P₀ . . . P₂₈ are directly read from the cache 652 and do not need to be decoded. The B-pictures, B_{0,1}, B_{0,2}, . . . B_{28,1}, B_{28,2} are displayed by decoding the B-pictures from the cached P-pictures.

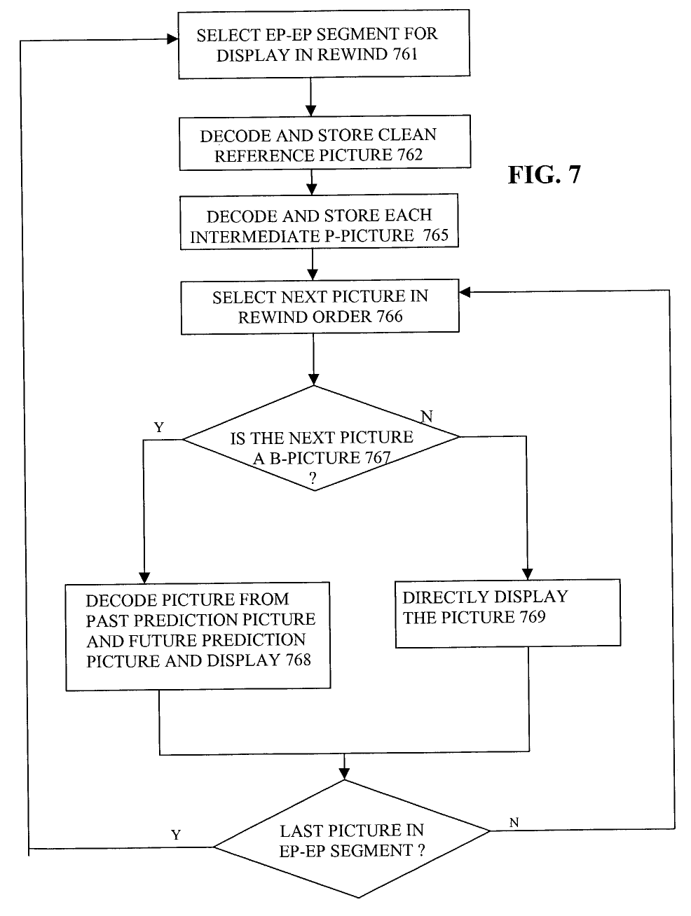

Referring now to FIG. 7, there is illustrated a flow diagram for storing intermediate P-pictures during rewind of a HITS stream. At 761, the EP-EP segment for display in rewind order is selected. At 762, the clean reference picture RP₀ is decoded and stored in a reference picture frame buffer 553. At 763, each intermediate P-picture P₀ . . . P₂₈ between the clean reference picture RP₀ and the last picture in the EP-EP segment, B_{28,2} is decoded 764 and stored 765 in the cache memory 552.

After storing the intermediate P-pictures P₀ . . . P₂₈ in the cache 552, the pictures are displayed in rewind order. The next picture for display in the rewind order is selected 766. If at 767, the picture for display is a B-picture, the B-picture is decoded and displayed (768) from the past prediction picture and the future prediction picture. The decompression engine transfers the past prediction picture and the future prediction picture used to decode the B-picture from the cache memory 552 to the frame buffer 553. The video decompression engine 551 decodes the picture for display and provides the decoded picture to the display engine for display. If at 767, the picture to be displayed is a P-picture, the P-picture is directly displayed (769). The video decompression engine 551 fetches the P-picture from the cache 552 and provides the P-picture to the display engine. The foregoing, 766-769, are repeated for each of the pictures in the EP-EP segment. After each of the pictures of the EP-EP segment are displayed, 761-768 are repeated for the next EP-EP segment in the rewind order.

Performance can be further improved by parallelizing the display of an EP-EP segment with the decode of the next EP-EP segment in the rewind order. While the pictures of one EP-EP segment are displayed, the pictures of the next EP-EP segment can be decoded and stored in the cache 552. In one embodiment, the cache can be divided in two sections where the pictures of the EP-EP segment for display are displayed from one section of the cache 552, while the pictures of the next EP-EP segment in the rewind order are stored in the other section of the cache 552.

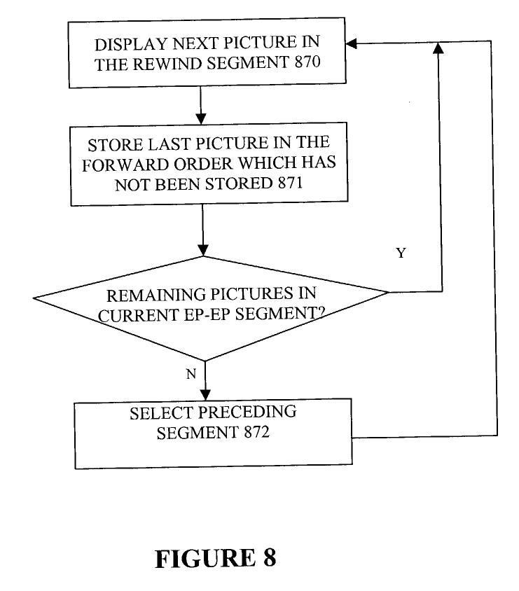

The memory for caching the pictures can be further reduced because once a picture has been displayed, the memory space required by the picture can be used for storing a picture from the previous EP-EP segment. Referring now to FIG. 8, there is illustrated a flow diagram for storing pictures from one EP-EP segment while displaying pictures from another EP-EP segment. Initially, the pictures EP-EP segment for display (the current segment) is stored in the cache 552 and the next EP-EP segment in the rewind order (the next segment) is to be stored. At 870, the next picture in the rewind sequence is displayed. After the picture is displayed at 870, the last picture in the forward order that has not been stored in the next segment is stored (871) in the memory space that held the picture displayed during 871. The foregoing, 870-871, are repeated for each picture in the current segment and the next segment. When each of the pictures of the current segment have been displayed and when each of the pictures of the next segment have been stored, the segment preceding the next segment (in the forward order) is selected (872). The next segment is displayed while the segment preceding the next segment is stored during 871-872.

The personal video recorder system 100 as described herein may be implemented as a board level product, as a single chip, application specific integrated circuit (ASIC), or with varying levels of the system integrated on a single chip with other portions of the system as separate components. The degree of integration of the monitoring system may primarily be determined by speed of incoming MPEG packets, and cost considerations. Because of the sophisticated nature of modem processors, it is possible to utilize a commercially available processor, which may be implemented external to an ASIC implementation of the present system. Alternatively, if the processor is available as an ASIC core or logic block, then the commercially available processor can be implemented as part of an ASIC device wherein the memory storing instructions is implemented as firmware.

In one embodiment can be implemented by insertion of command packets within the MPEG TS with appropriate TS formatted trick play commands by a host processor, such as host processor described in “Command Packets for Personal Video Recorders”, app. Ser. No. 60/426,850, by Kellerman, et. al, which is incorporated by reference.

While the invention has been described with reference to certain embodiments, it will be understood by those skilled in the art that various changes may be made and equivalents may be substituted without departing from the scope of the invention. In addition, many modifications may be made to adapt particular situation or material to the teachings of the invention without departing from its scope. Therefore, it is intended that the invention not be limited to the particular embodiment(s) disclosed, but that the invention will include all embodiments falling within the scope of the appended claims.

1. A method for displaying pictures, said method comprising:
decoding a first plurality of pictures;
storing each of the first plurality of decoded pictures; and
displaying each of the first plurality of pictures in rewind order.

2. The method for displaying pictures of claim 1, wherein storing the plurality of pictures further comprises:
scaling down each of the first plurality of pictures; and
storing the scaled down pictures.

3. The method of claim 1, further comprising:
storing a second plurality of pictures while displaying the first plurality of pictures in rewind order.

4. The method of claim 3, wherein storing a second plurality of pictures while displaying the first plurality of pictures further comprises:
displaying a particular one of the first plurality of pictures; and
storing a particular one of the second plurality of pictures, responsive to displaying the particular one of the first plurality of pictures.

5. The method of claim 1, wherein the first plurality of pictures comprises an EP-EP segment.

6. The method of claim 1, wherein the first plurality of pictures comprises each of the prediction pictures of an EP-EP segment.

7. The method of claim 6, further comprising:
decoding another plurality of pictures, wherein each of the another plurality of pictures are data dependent on the first plurality of pictures; and
displaying the second plurality along with the first plurality of pictures in reverse or fast forward order

8. A decoder for displaying pictures, said decoder comprising:
a decompression engine for decoding a first plurality of pictures;
a cache for storing each of the first plurality of decoded pictures; and
a display engine for displaying each of the first plurality of pictures in rewind order.

9. The decoder of claim 8, wherein the cache stores a plurality of scaled down pictures.

10. The decoder of claim 8, wherein the caches comprises:
a first portion for storing the first plurality of pictures; and
a second portion for storing a second plurality of pictures while the display engine displays the first plurality of pictures in rewind order.

11. The decoder of claim 8, wherein the cache comprises a particular location for storing a particular one of the first plurality of pictures and the second plurality of pictures, and wherein the particular one of the second plurality of pictures overwrites the particular one of the first plurality of pictures, responsive to displaying the particular one of the first plurality of pictures by the display engine.

12. The decoder of claim 8, wherein the first plurality of pictures comprises an EP-EP segment.

13. The decoder of claim 8, wherein the first plurality of pictures comprises each of the prediction pictures of an EP-EP segment.

14. The decoder of claim 13, wherein the decompression engine decodes another plurality of pictures, wherein each of the another plurality of pictures are data dependent on the first plurality of pictures.

15. A circuit for displaying pictures, said circuit comprising:
a memory for storing a plurality of instructions;
a controller for executing the plurality of instructions, said controller connected to the memory; and
wherein execution of the instructions by the processor comprising causing:
decoding a first plurality of pictures;
storing each of the first plurality of decoded pictures; and
displaying each of the first plurality of pictures in rewind order.

16. The circuit of claim 15, wherein causing storing the plurality of pictures further comprises causing:
scaling down each of the first plurality of pictures; and
storing the scaled down pictures.

17. The circuit of claim 15, wherein execution of the instructions by the controller further comprises causing:
storing a second plurality of pictures while displaying the first plurality of pictures in rewind order.

18. The circuit of claim 17, wherein causing storing a second plurality of pictures while displaying the first plurality of pictures further comprises causing:
displaying a particular one of the first plurality of pictures; and
storing a particular one of the second plurality of pictures, responsive to displaying the particular one of the first plurality of pictures.

19. The circuit of claim 15, wherein the first plurality of pictures comprises an EP-EP segment.

20. The circuit of claim 15, wherein the first plurality of pictures comprises each of the prediction pictures of an EP-EP segment.

21. The circuit of claim 20, wherein execution of the instructions comprises further causing:
decoding another plurality of pictures, wherein each of the another plurality of pictures are data dependent on the first plurality of pictures.
